(19) United States
(12) Patent Application Publication
(10) Pub. No.: US 2005/0131724 A1
(43) Pub. Date: Jun. 16, 2005

(54) Enhanced online auction method and apparatus

(76) Inventor: Danny Clay, Springville, UT (US)

Correspondence Address: KUNZLER & ASSOCIATES, 8 EAST BROADWAY, SALT LAKE CITY, UT, 84111, US

(21) Appl. No.: 10/965,646

(22) Filed: Oct. 14, 2004

Related U.S. Application Data
(60) Provisional application No. 60/529,506, filed on Dec. 15, 2003.

(51) Int. Cl. G06F 17/60

(52) U.S. Cl. 705/1

(57) ABSTRACT

An enhanced online auction system enables users to submit item-wanted postings in addition to item-available postings and facilitates deferred pairing of buyers and sellers. Users such as buyers, sellers, traders, and agents may use the auction system to search the item-wanted postings, the item-available postings, or both. Item-available postings may be offered for auction, immediate-sale, or best-offer sale. Item-wanted listings may be solicited for reverse-auction, immediate-purchase, or best-offer purchase. In one embodiment, a commerce server of the present invention includes a data store that stores postings corresponding to items offered-for-sale and items wanted-for-purchase, a query module that finds postings within the data store, and a browser interface module that serves web pages for receiving listing criteria and display listings that match the listing criteria. Item-wanted listings may be marked with an identifying mark in order to distinguish item-wanted listings from offered-for-sale listings.

### CROSS-REFERENCES TO RELATED APPLICATIONS

This application claims the benefit of U.S. Provisional Patent Application No. 60/529,506 entitled “ENHANCED ONLINE AUCTION METHOD APPARATUS AND SYSTEM” and filed on Dec. 15, 2003 for Danny Clay, Steven F. McDaniel, and Morgan B. Adair.

### BACKGROUND OF THE INVENTION

1. Field of the Invention

The present invention relates to auctioning items for sale on an internetwork. Specifically, the invention relates to apparatus, methods, and systems for online auction trading.

2. Description of the Related Art

FIG. 1 is a schematic diagram depicting a prior art online trading system 100. The prior art online auction trading system 100 includes one or more auction web servers 110, a commerce database 115 that may include a plurality of database replicas such as partitions 115a and 115b, an inter-network 120, seller workstations 130, seller data stores 135, and buyer workstations 140. The prior art online trading system 100 enables sellers of merchandise and services to post items for auction, and buyers to search or browse for items available for sale. While the online auction trading system 100 enables certain transactions between buyers and sellers, it does not provide means for buyers to post item-wanted listings, or for sellers to search for items that buyers want to purchase.

FIG. 2 is a schematic illustration of a typical prior art online trading search interface 200. The prior art search interface 200 includes a search dialog 210, search dialog tabs 220, a search keyword text field 230, search parameter interface elements 240, search results interface elements 250, a search initiation interface element 260, a search results page 270, and search results list 280. The prior art search interface 200 provides a basic user interface for searching a commerce database for items that sellers have offered-for-sale. However, the prior art search interface 200 does not provide for item-wanted listings or facilitate sellers searching for item-wanted listings.

Accordingly, what is needed is an enhanced online auction system that expedites buyers creating item-wanted listings, enables sellers to search item-wanted listings, and facilitates deferred pairing of buyers and sellers.

### SUMMARY OF THE INVENTION

The present invention has been developed in response to the present state of the art, and in particular, in response to the problems and needs in the art that have not yet been fully solved by currently available online auction systems. Accordingly, the present invention has been developed to provide an enhanced online auction apparatus and method that overcome many or all of the above-discussed shortcomings in the art.

The apparatus for facilitating online commerce is provided with a logic unit containing a plurality of modules configured to functionally execute the necessary steps of providing an online service that finds postings within a data store and displays a plurality of listings to a user. These modules in the described embodiments include a query module and a browser interface module.

The apparatus, in one embodiment, facilitates posting items wanted-for-purchase through an online auction. The apparatus may comprise a data store containing postings that correspond to items wanted-for-purchase as well as items offered-for-sale. Furthermore, a query module may be provided to find postings within the data store that match selected criteria. A browser interface module may serve at least one web page configured to display listings that match the selected criteria. The criteria may be specified by the seller, buyer, auction trader, or the like. As a result, buyers may generate postings for items wanted-for-purchase, sellers may search item-wanted postings looking for sale opportunities, and auction traders may facilitate buy and sell transactions for the same item.

The apparatus is further configured, in one embodiment, to list postings corresponding to items offered-for-sale that are classified as auction postings, immediate-sale postings, best-offer postings and the like. The items wanted-for-purchase may be reverse-auction postings, immediate-purchase postings, best-offer postings, and the like. In addition, the postings may correspond to used items.

In certain embodiments, one or more users may be automatically notified when a posting for an item offered-for-sale matches a wanted-item posting. Automatic notification facilitates deferred pairing of buyers and sellers and informs users of opportunities without requiring diligent monitoring of the auction system.

A method of the present invention is also presented for facilitating online commerce. The method in the disclosed embodiments substantially includes the steps necessary to carry out the functions presented above with respect to the operation of the described apparatus. In one embodiment, the method includes storing postings corresponding to both items offered-for-sale and items wanted-for-purchase within a data store. The method may further include receiving selected criteria and finding postings within the data store that match the selected criteria. The method may also include providing and/or displaying listings that match the selected criteria.

In yet another embodiment, the method may include receiving criteria from a user, providing the selected criteria to a commerce server, receiving a plurality of listings that conform to the selected criteria, and displaying the plurality of listings to a user. The plurality of listings may comprise a listing for an item available-for-purchase and a listing for an item wanted-for-purchase. The items wanted-for-purchase may be displayed anonymously.

The present invention facilitates online commerce. Reference throughout this specification to specific features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment. Furthermore, the described features, advantages, and characteristics of the invention may be combined in any suitable manner in one or more embodiments.

One skilled in the relevant art will recognize that the invention may be practiced without one or more of the specific features or advantages of a particular embodiment. In other instances, additional features and advantages may be recognized in certain embodiments that may not be present in all embodiments of the invention. These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram illustrating a typical prior art online trading system;

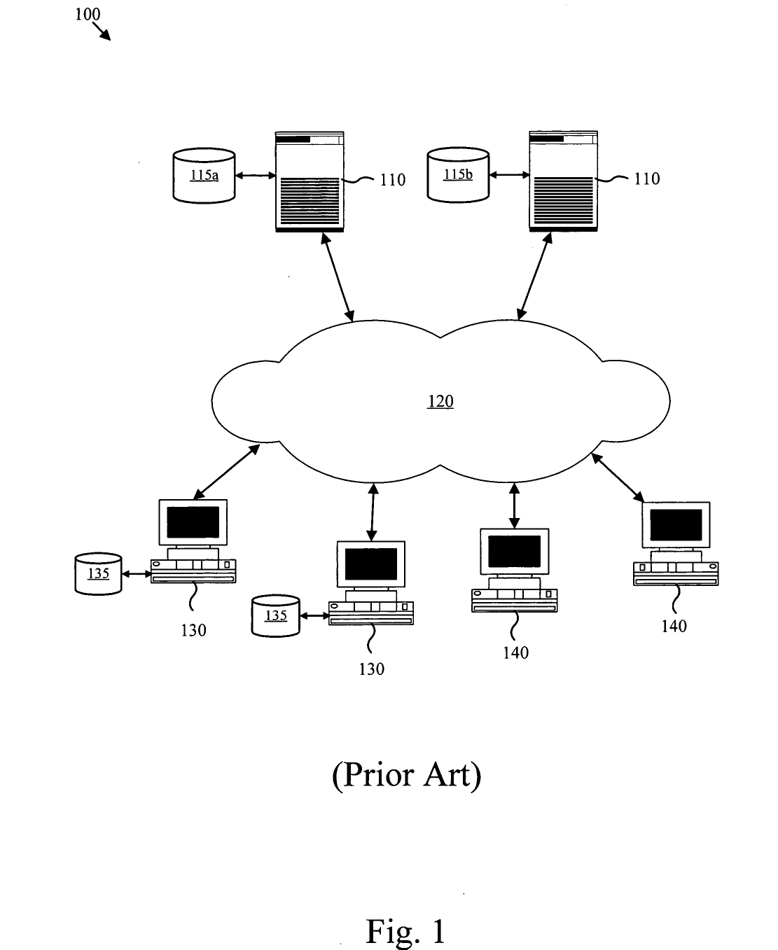

FIG. 2 is a schematic illustration of a typical prior art online trading search interface;

FIG. 3 is a block diagram depicting one embodiment of an online commerce server of the present invention;

FIG. 4 is a flow chart diagram depicting one embodiment of a online trading method of the present invention;

FIG. 5 is a schematic illustration depicting one embodiment of a posting dialog of the present invention;

FIG. 6 is a flow chart diagram depicting one embodiment of a browsing method of the present invention;

FIG. 7 is a schematic illustration depicting one embodiment of an enhanced search dialog of the present invention; and

FIG. 8 is a schematic illustration depicting two embodiments of an enhanced search results page of the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

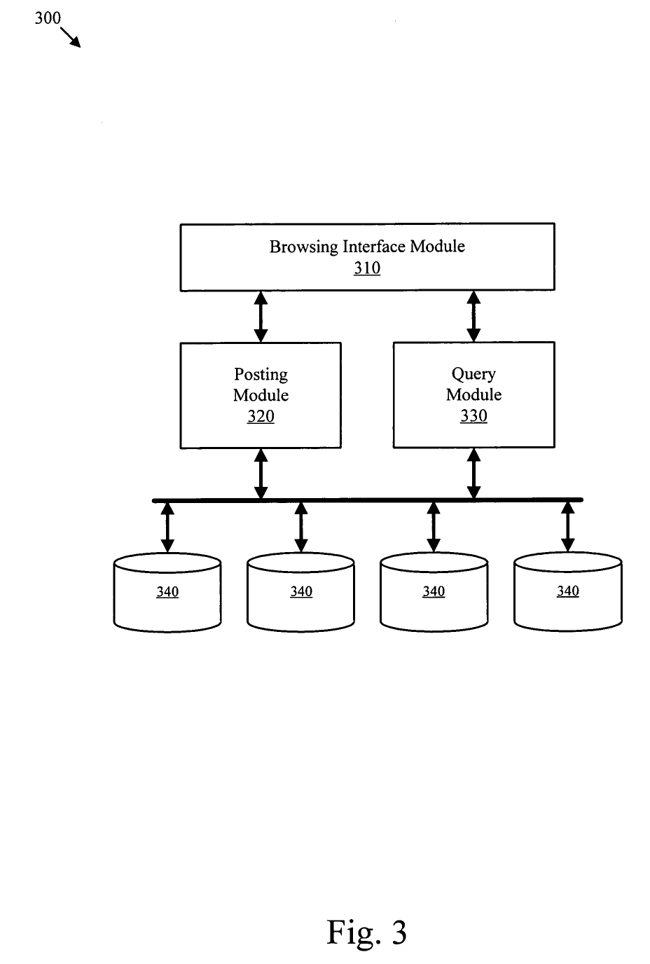

FIG. 3 illustrates one embodiment of a commerce server 300 of the present invention. The commerce server 300 includes a browsing interface module 310, a posting module 320, a query module 330, and one or more data stores 340 which in one embodiment is a database. The commerce server 300 enables a user to search the data stores 340 for items offered-for-sale, and items wanted-for-purchase. The user may also submit postings to the data stores 340 corresponding to items offered-for-sale and items wanted-for-purchase. The user may constitute a buyer, a seller, a trader, an agent, or the like.

In certain embodiments, the browsing interface module 310 enables a user equipped with a standard browser to conduct commerce-related operations relative to postings stored on the data stores 340. In one embodiment, the browsing interface module 310 serves web pages for generating postings, conducting searches, viewing listings, and conducting transactions.

The posting module 320 receives posting information from the browsing interface module 310 and provides such information to the data stores 340. In one embodiment, the posting module is configured to interface with a database residing on the data stores 340.

The postings may correspond to items offered-for-sale and items wanted-for-purchase. Postings for items offered-for-sale may include auction postings, immediate-sale postings, and best-offer postings. Auction postings are used to enable a bidding process such as the highest bidder within a specified time period. Immediate-sale postings enable the first buyer that agrees to certain terms to purchase the item offered-for-sale. Best offer postings enable a seller to select the most attractive offer or trade from a set of offers or trades based on additional factors other than price.

Postings for items wanted-for-purchase may include reverse-auction postings, immediate-purchase postings, and best-offer postings. Reverse-auction postings enable a reverse bidding process such as multiple sellers competing to provide an item wanted-for-purchase at the best price. Immediate-purchase postings enable the first seller that agrees to certain terms to sell the item wanted-for-purchase. A best offer posting for an item wanted-for-purchase enables a buyer to select the most attractive offer or trade from a set of offers or trades based on additional factors other than price.

In certain embodiments, one or more users may be automatically notified when a posting for an item offered-for-sale matches a wanted-item posting. Automatic notification facilitates deferred pairing of buyers and sellers and informs users of opportunities without requiring diligent monitoring of the auction system.

The query module 330 finds postings stored within the data stores 340 that match selected criteria. In the depicted embodiment, the query module 330 receives the selected criteria from the browsing interface module and initiates a search of the data stores 340 for postings matching the selected criteria.

The query module 330 may provide search results in the form of listings to the browsing interface module which may format the listings for viewing. In certain embodiments, wanted-for-purchase listings are marked with an item-wanted mark in order to distinguish them from offered-for-sale listings. Examples of item-wanted marks include a label, an icon, a magnifying glass, a spyglass, a telescope, a missing poster, and a wanted poster. Certain labels may be acronyms such as ‘ISO’ (“in search of”), ‘WTB’ (“wanted to buy”), or ‘GHI’ (“gotta have it”), or the like.

In addition to postings and listings related to items offered-for-sale, the commerce server 300 supports postings and listings for items wanted-for-purchase. Hence, sellers and auction traders may benefit from knowing what potential buyers are in need of and buyers have an avenue to purchase items that are not currently offered for sale.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the order in which a particular method occurs may or may not strictly adhere to the order of the corresponding steps shown.

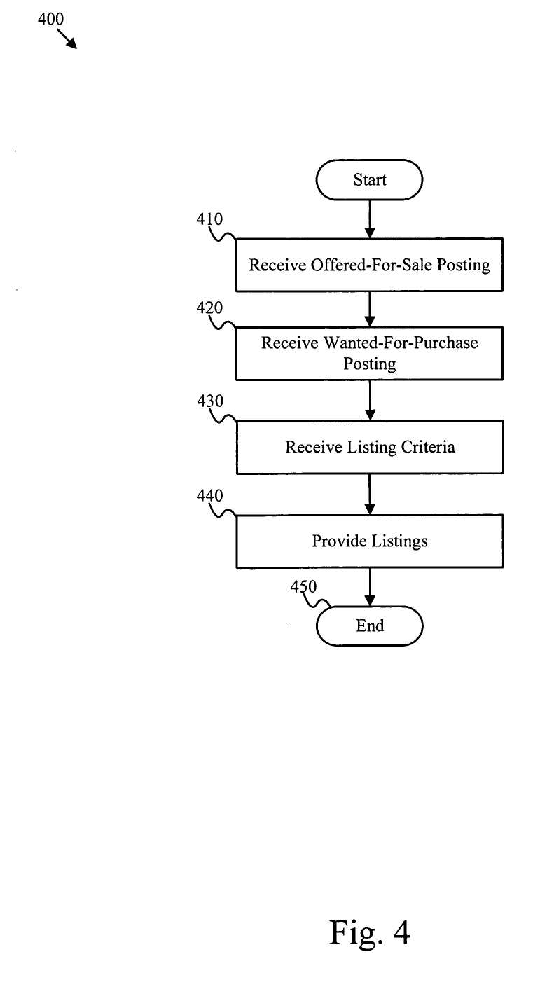

FIG. 4 is a flow chart diagram depicting one embodiment of an online trading method 400. The online trading method 400 includes a receive offered-for-sale posting step 410, a receive wanted-for-purchase posting step 420, a receive listing criteria step 430, and a provide listings step 440. The method 400 enables an online auction site to provide a double service that permits a user to post a listing for both items offered-for-sale and for items wanted-for-purchase and also permits the user to query both types of postings.

Referring now to FIGS. 3 and 4, in one embodiment, the method 400 begins and the posting module 320 receives 410 one or more postings for an item offered-for-sale. The posting module 320 may also receive 420 one or more postings for an item wanted-for-purchase. One or more users may post both types of postings through the browsing interface 310. The postings may be stored within a data store 340.

Subsequently, the query module 330 may receive 430 listing criteria from a user through the browsing interface 310. The listing criteria may determine the types of postings the user prefers to view. The query module 330 may search the data stores 340 for the specific postings and then may provide 440 the listings that match the selected criteria to the user through the browser interface 310. Providing 440 the listings may comprise serving at least one web page. Subsequently the method 400 ends 450.

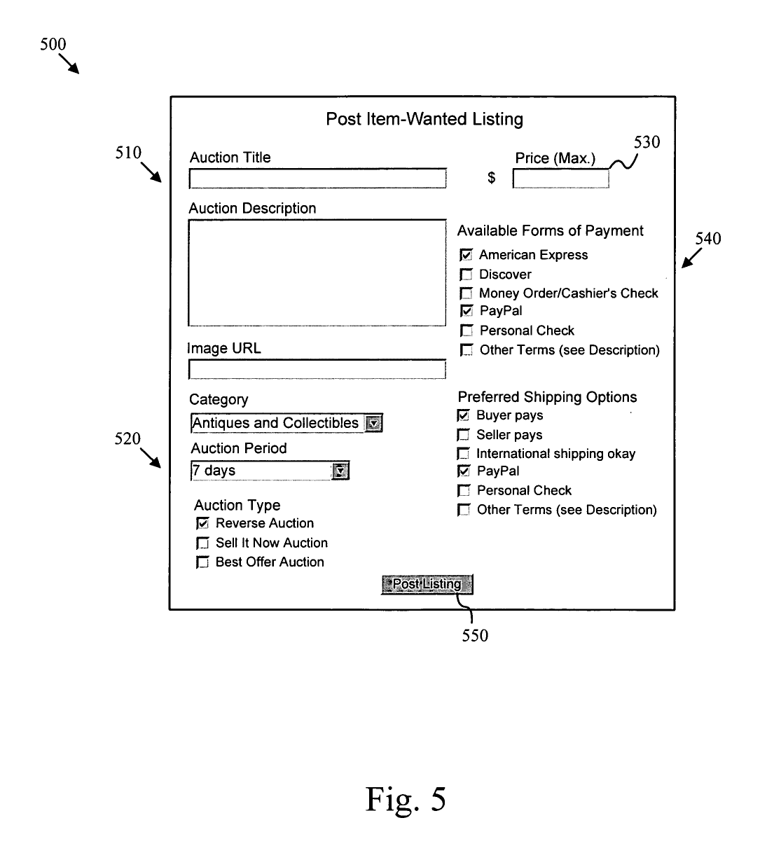

FIG. 5 is a schematic illustration depicting one embodiment of a posting dialog 500 of the present invention. The depicted posting dialog 500 includes one or more auction description fields 510, auction parameters 520, a pricing field 530, payment and shipping fields 540, and a posting control 550. The posting dialog 500 enables a buyer or trader to submit item-wanted postings to the commerce data store 340.

The auction description fields 510 receive information describing the item the buyer would like to purchase. Examples of the fields 510 include an auction title, an item description, a URL for the location of an image file containing a picture of the item wanted-for-purchase, and a category for the item-wanted posting. Examples of category selections include new items, used items, collectable items, antique items, and the like. In one embodiment, the auction description fields enable a buyer to include a description of items the buyer is willing to trade for the item wanted-for-purchase.

The auction parameters 520 enable the buyer to specify information about the auction. Examples of the auction parameters 520 include the duration of the auction, and a definition of the auction type such as reverse-auction, immediate-purchase auction, best-offer auction, or the like.

The pricing field 530 enables the user to specify the maximum price the buyer is willing to pay for the item wanted-for-purchase. The payment and shipping options 540 enable the buyer to optionally specify what methods of payment the buyer has available for payment and acceptable methods of shipping. In one embodiment, the payment and shipping options 540 include separate shipping options for domestic and international shipping.

The posting control 550 initiates a posting process into the commerce data store 340 for the data entered by the buyer. In one embodiment, the item-wanted listing dialog 500 includes a method for validating data entered by the buyer before the data is transmitted to the commerce server 300, or the like.

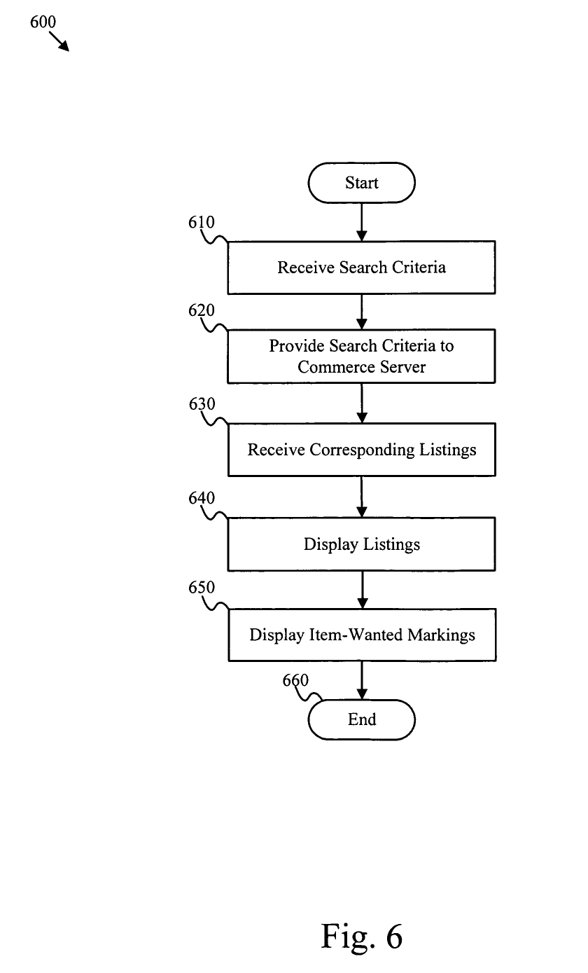

FIG. 6 is a flow chart diagram depicting one embodiment of a browsing method 600 of the present invention. The depicted browsing method 600 includes receiving 610 listing criteria, providing 620 the listing criteria to a commerce server, receiving 630 corresponding listings, displaying 640 the listings, and displaying 650 item-wanted markings. The method 600 enables one or more users to search a data store 340 for postings that correspond to selected criteria.

The browsing method 600 begins by receiving 610 the listing criteria. The listing criteria may include receiving any type of criteria useful for navigating or finding postings and need not be associated with a search operation. For example, the listing criteria may correspond to specific links activated by the user. Alternately, the listing criteria may correspond keywords entered into a search dialog.

The method continues by providing 620 the listing criteria to a commerce server such as the commerce server 300. Subsequently, the listings corresponding to the selected criteria are then received 630, and displayed 640. The listings corresponding to item-wanted postings may be displayed 650 with an item-wanted mark or symbol.

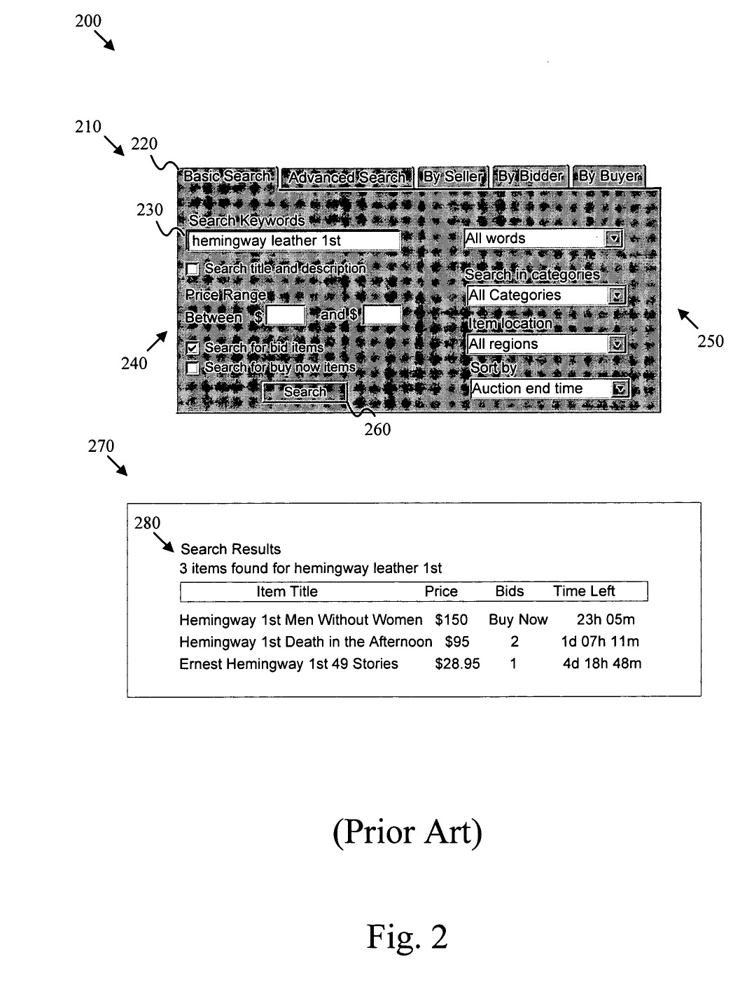

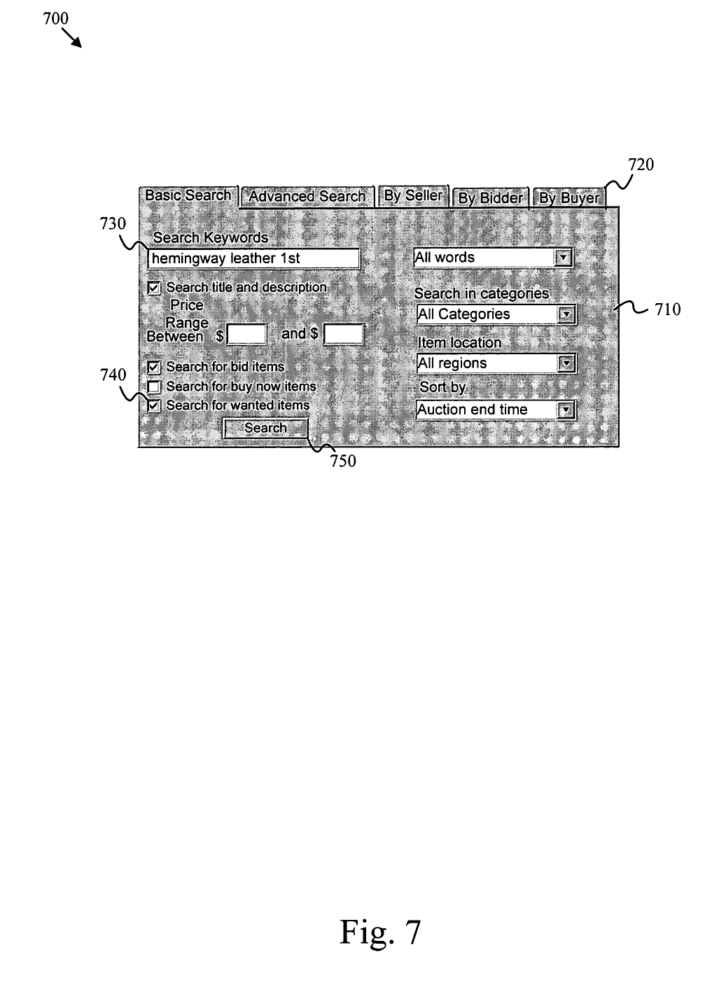

FIG. 7 is a schematic illustration depicting one embodiment of an enhanced search interface 700 of the present invention. The depicted search interface 700 includes a search dialog 710, a search ‘By Buyer’ tab 720, a search field 730, a search for wanted items checkbox 740, and a search control 750. The search interface 700 provides enhanced auction features to buyers and sellers beyond those provided by the prior art search dialog 210 shown in FIG. 2.

The depicted search dialog 710 may contain all of the search dialog components of the prior art search dialog 210. The depicted search dialog 710 facilitates a user searching the commerce data store 340 for item-wanted listings by entering keywords into the search field 730, checking the ‘Search for wanted items’ checkbox 740, and clicking the search control 750. The search ‘By Buyer’ tab 720 facilitates searching the commerce data store 340 for item-wanted listings by entering the user name or identification number of the buyer who posted the item-wanted listing.

In the depicted embodiment, a search for a wanted-item listing is performed by checking the ‘Search for wanted items’ checkbox 740. In certain embodiments, item-wanted listings may be identified in the commerce data store 340 by a unique sequence of alphanumeric characters in the item description. For example, item-wanted listing descriptions may begin with an acronym such as ‘ISO’ (“in search of”), ‘WTB’ (“wanted to buy”), or ‘GHI’ (“gotta have it”) to identify that the listing is for an item the potential buyer is searching for.

By facilitating searches for item-wanted listings, the search interface 700 expedites transactions between buyers and potential sellers. Sellers may search item-wanted listings to measure demand for items the seller may offer for sale, to estimate the market price of wanted items, to identify new products the seller may be able to sell profitably, to identify product features desired by potential purchasers, or to identify potential purchasers that may be contacted when an item is listed for sale.

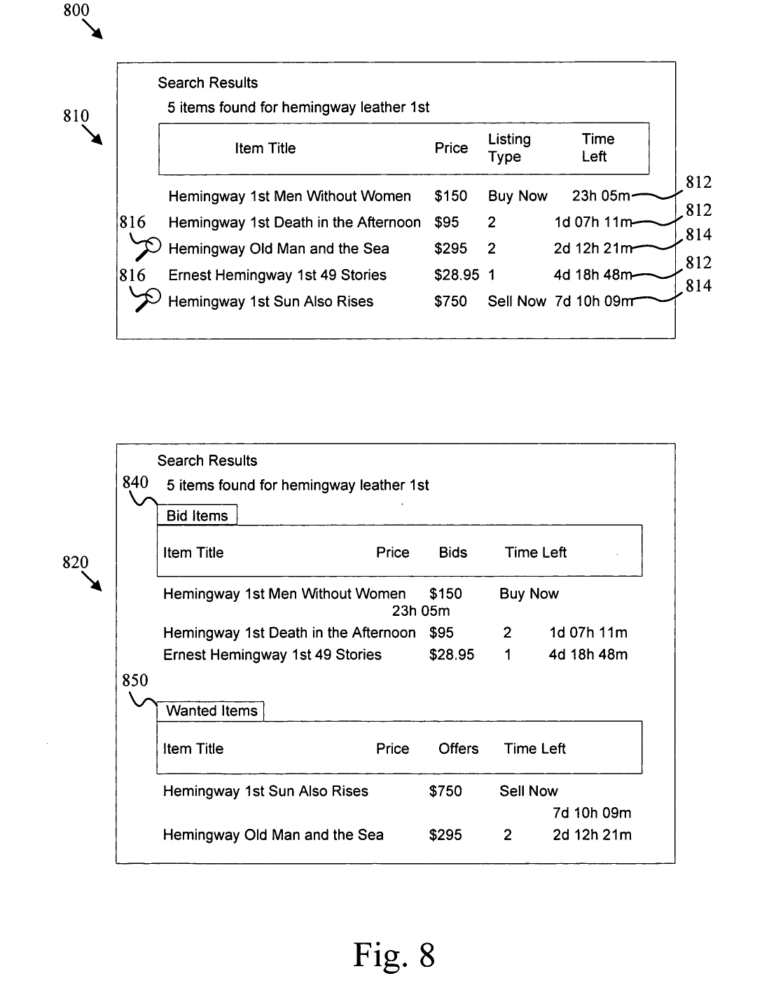

FIG. 8 is a schematic illustration depicting two embodiments of an enhanced search results page 800 of the present invention namely a search results page 810 and a search results page 820. The search results pages 800 may include all of the components specified through the auction search interface 700.

The depicted search results page 810 simultaneously displays information regarding items available-for-sale 812 and items wanted-for-purchase 814. The search results page 810 preferably displays a list of items found in a search of the commerce data store 340. The search results page 810 may include auction items and wanted items, as specified by search parameters entered in the search dialog 710 by the user. The items wanted-for-purchase may be identified by a symbol 816, such as a magnifying glass or other icon.

The search results page 820 displays multiple lists of auction items returned by a search of the commerce data store 340. One list may include the auction items list 840. The depicted auction items list 840 includes an auction item title, a current bid price, a bid number, and a remaining time indicator. The auction items list 840 may resemble search results available from a typical auction search known in the art. However, the search results page 820 further includes a wanted items list 850.

The wanted items list 850 displays a list of wanted items returned by a search of the commerce data store 340. The wanted items list 850 may include fields such as the auction item title, the current offering price, if any, the number of offers, and the time remaining in the auction.

In some embodiments, the wanted items list 850 may identify the potential buyer listing the item-wanted listing. In other embodiments, the wanted items list 850 may display item-wanted listings anonymously. Anonymous display of items-wanted listings promotes communication of potential buyer demand to sellers without providing a means for contact between sellers and potential buyers outside the auction system. In this way, anonymous display of items-wanted listings helps protect the profitability of the auction system. In certain embodiments, the wanted items list 850 may include a mechanism for allowing sellers to notify anonymous creators of item-wanted listings when an item possibly matching an item-wanted listing is listed for sale.

The present invention facilitates improved online commerce. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus for facilitating online commerce, the apparatus comprising:
a data store configured to store postings corresponding to items offered-for-sale;
the data store further configured to store postings corresponding to items wanted-for-purchase; and
a query module configured to find postings within the data store that match selected criteria.

2. The apparatus of claim 1, further comprising a browser interface module configured to serve at least one web page configured to display listings to a user that correspond to the postings within the data store that match the selected criteria.

3. The apparatus of claim 2, wherein the browser interface module is further configured to place a wanted-item mark in proximity to listings corresponding to an items wanted-for-purchase.

4. The apparatus of claim 3, wherein the wanted-item mark is selected from the group consisting of an acronym, a label, an icon, a magnifying glass, a spyglass, a telescope, a missing poster, and a wanted poster.

5. The apparatus of claim 3, wherein the wanted-item mark is an acronym selected from the group consisting of ‘ISO’ (“in search of”), ‘WTB’ (“wanted to buy”), and ‘GHI’ (“gotta have it”).

6. The apparatus of claim 1, wherein the postings corresponding to items offered-for-sale are selected from the group consisting of auction postings, immediate-sale postings, and best-offer postings.

7. The apparatus of claim 1, wherein the postings corresponding to items wanted-for-purchase are selected from the group consisting of reverse-auction postings, immediate-purchase postings, and best-offer postings.

8. The apparatus of claim 1, wherein a posting corresponds to a new item.

9. The apparatus of claim 1, wherein a posting corresponds to a used item.

10. A method for facilitating online commerce, the method comprising:
storing postings corresponding to items offered-for-sale within a data store;
storing postings corresponding to items wanted-for-purchase within the data store;
receiving selected criteria; and
finding postings within the data store that match the selected criteria.

11. The method of claim 10, further comprising placing a wanted-item mark in proximity to listings corresponding to an items wanted-for-purchase.

12. The method of claim 11, wherein the wanted-item mark is selected from the group consisting of a label, an icon, a magnifying glass, a spyglass, a telescope, a missing poster, and a wanted poster.

13. The method of claim 11, wherein the wanted-item mark is an acronym selected from the group consisting of ‘ISO’ (“in search of”), ‘WTB’ (“wanted to buy”), and ‘GHI’ (“gotta have it”).

14. The method of claim 10, wherein the postings corresponding to items offered-for-sale are selected from the group consisting of auction postings, immediate-sale postings, and best-offer postings.

15. The method of claim 10, wherein the postings corresponding to items wanted-for-purchase are selected from the group consisting of reverse-auction postings, immediate-purchase postings, and best-offer postings.

16. The method of claim 10, further comprising providing listings that correspond to the postings within the data store that match the selected criteria.

17. The method of claim 16, wherein providing listings comprises serving at least one web page.

18. The method of claim 10, further comprising notifying a user when an offered-for-sale posting matches a wanted-for-purchase posting.

19. The method of claim 10, wherein a posting corresponds to a new item.

20. The method of claim 10, wherein a posting corresponds to a used item.

21. A method for facilitating online commerce, the method comprising:
receiving selected criteria from a user;
providing the selected criteria to a commerce server;
receiving a plurality of listings that conform to the selected criteria, the plurality of listings comprising a listing for an item available-for-purchase and a listing for an item wanted-for-purchase; and
displaying the plurality of listings to a user.

22. The method of claim 21, further displaying a wanted-item mark in proximity to a listings corresponding to an items wanted-for-purchase.

23. The method of claim 22, wherein the wanted-item mark is selected from the group consisting of a label, an icon, a magnifying glass, a spyglass, a telescope, a missing poster, and a wanted poster.

24. The method of claim 21, wherein the listing for an item wanted-for-purchase is selected from the group consisting of a reverse-auction listing, an immediate-purchase listing, and a best-offer listings.

25. The method of claim 21, wherein the listing for an item available-for-purchase is selected from the group consisting of an auction listing, an immediate-sale listing, and a best-offer listing.

26. The method of claim 21, wherein the listing for an item wanted-for-purchase specifies a new item.

27. The method of claim 21, wherein the listing for an item wanted-for-purchase specifies a used item.

28. The method of claim 21, wherein the listing for an item wanted-for-purchase is displayed anonymously.
